(19) United States
(12) Patent Application Publication
(10) Pub. No.: US 2017/0225416 A1
(43) Pub. Date: Aug. 10, 2017

(54) A METHOD AND A SUPPORT SYSTEM FOR AN UNCURED TIRE CARCASS

(71) Applicant: Sid BORDELON, Simpsonville, SC (US)

(72) Inventor: Sid BORDELON, Simpsonville, SC (US)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/515,397

(22) PCT Filed: Sep. 30, 2014
(86) PCT No.: PCT/US2014/058401

§ 371 Date: Mar. 29, 2017

(51) Int. Cl. B29D 30/00

(52) U.S. Cl. CPC B29D 30/0016; B29D 30/00; B29D 2030/0022

(57) ABSTRACT

The invention comprises a support system and method for supporting an uncured tire carcass (10) for storage, handling and transport of the tire carcass during tire production operations. The method for supporting an uncured tire carcass (10) includes the step of configuring an uncured tire carcass in a storage configuration subsequent to removing the uncured tire carcass from the tire carcass building surface. Once removed from the tire carcass building surface the uncured tire carcass (10) is separate from the tire carcass building surface. The method further includes the step of pressurizing an interior chamber of the uncured tire carcass (10) to form an inflated uncured tire carcass.

### BACKGROUND OF THE INVENTION

Field of the Invention

This invention relates generally to storing, handling and transporting tire carcasses, and more particularly, storing, handling and transporting uncured tire carcasses during the production operations of the tire carcasses.

Description of the Related Art

Production of new tires commonly employs processes incorporating multiple steps, where different portions of the tire are formed and ultimately assembled and cured. For example, for certain processes, uncured tire carcasses are formed on a building surface and subsequently removed and transferred for subsequent processing in assembling a new tire, such as to later receive a belt package and a tread. Additionally, before undergoing further processing, the uncured tire carcass may be placed in temporary storage. Because the tire carcasses are uncured during storage and transfer, the tire carcasses are susceptible to collapse or bending. Additionally, when collapsing sufficiently, the uncured tire carcass can become unusable, such as when the carcass adheres to itself and cannot be properly returned to its original condition. For at least these reasons, there is a need to improve the structural stability of an uncured tire carcass after it has been dismounted from a building surface and placed in a storage position for transfer later processing to avoid damage and loss of uncured tire carcasses.

### SUMMARY OF THE INVENTION

The invention comprises a support system and method for supporting an uncured tire carcass for storage, handling and transport of the tire carcass during tire production operations. Particular embodiments of the method for supporting an uncured tire carcass include the step of configuring an uncured tire carcass in a storage configuration subsequent to removing the uncured tire carcass from the tire carcass building surface. Once removed from the tire carcass building surface the uncured tire carcass is separate from the tire carcass building surface. The method further includes the step of pressurizing an interior chamber of the uncured tire carcass to form an inflated uncured tire carcass.

Other embodiments of the invention comprise a support system for supporting an uncured tire carcass, which comprises a first end cap positioned at a first axial end of a tire carcass wherein the first axial end of the tire carcass is open to an inside of the tire carcass, the first end cap configured to at least partially cover the first axial end. The first end cap comprises, a first end cap passageway open to the inside of the tire carcass wherein the first end cap passageway is connected to a pressure source, where the pressure source communicates positively-pressured gas into an interior chamber of the tire carcass through the first end cap passageway.

Yet further embodiments of the invention comprise a support system for supporting an uncured tire carcass, the support system comprising a first end cap positioned at a first axial end of a tire carcass wherein the first axial end of the tire carcass is open to an inside of the tire carcass; the first end cap configured to substantially cover the first axial end. The first end cap comprises a first end cap passageway open to the inside of the tire carcass wherein the first end cap passageway is connected to a pressure source, the pressure source communicates positively-pressured gas into an interior chamber of the tire carcass through the first end cap passageway.

The foregoing and other objects, features and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

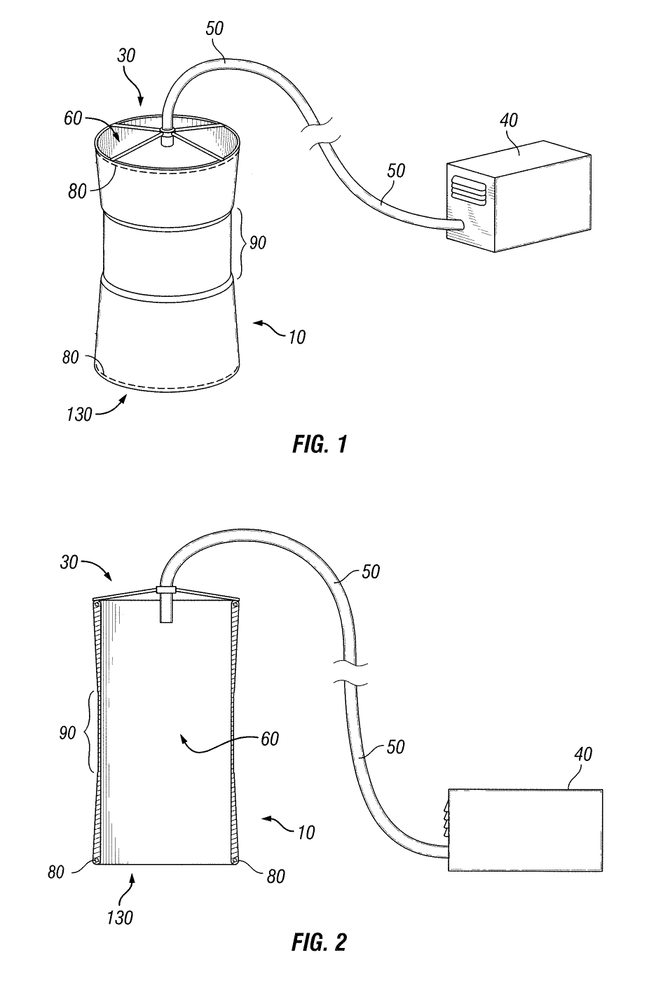

FIG. 1 is a perspective view of an uncured tire carcass with a pressure source for supplying positively-pressurized gas to an uncured tire carcass during tire production operations, in accordance with an embodiment of the invention.

FIG. 2 is a cross-sectional view taken axially across the uncured tire carcass for supporting the uncured tire carcass during tire production operations as shown in FIG. 1.

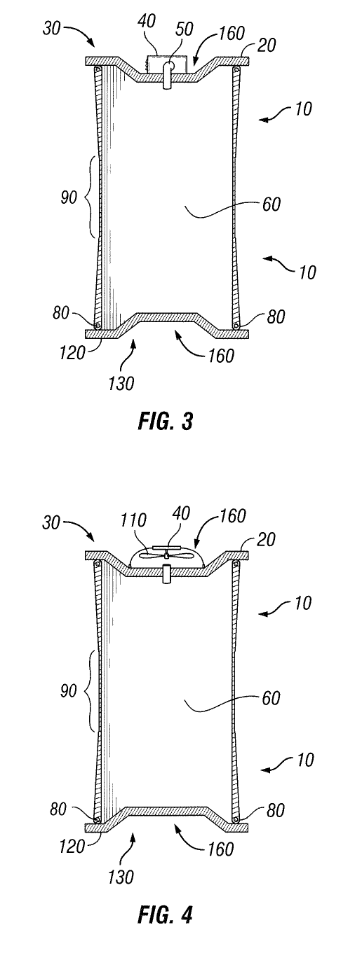

FIG. 3 is a cross-sectional view taken axially across the uncured tire carcass with a first end cap, a second end cap, and a pressure source for supporting the uncured tire carcass during tire production operations, in accordance with an embodiment of the invention.

FIG. 4 is a cross-sectional view taken axially across the uncured tire carcass with a first end cap, a second end cap, and a pressure source for supporting the uncured tire carcass during tire production operations, where the pressure source is a fan, in accordance with an embodiment of the invention.

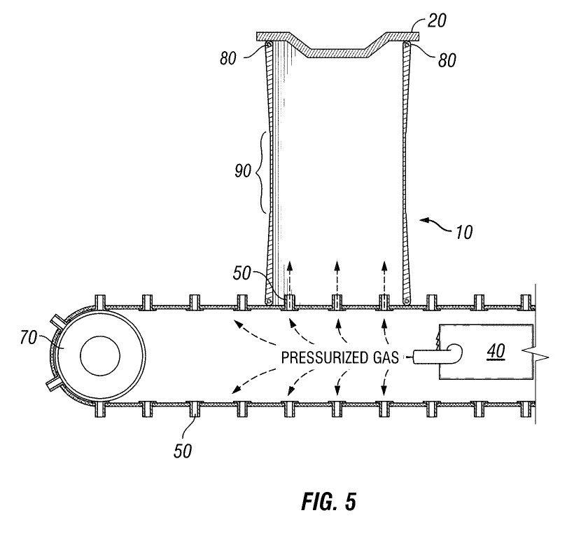

FIG. 5 is a cross-sectional view taken axially across the uncured tire carcass with a first end cap and a conveyor, the conveyor is a second end cap wherein the pressure source is within the structure of the conveyor, in accordance with an embodiment of the invention.

### DETAILED DESCRIPTION OF PARTICULAR EMBODIMENTS

As noted above, uncured tire carcasses are in need of additional support after being removed from a tire carcass building surface, such as a building surface, when in a storage arrangement or configuration. An uncured tire carcass is commonly referred to as a green tire carcass, and includes one or more plies of reinforced polymeric material extending between annular beads. Commonly, a ply of reinforced polymeric material comprises a sheet, where elongate reinforcements are spaced within a polymeric matrix. The elongate reinforcements comprise any known cord material, which may be formed of fabric, such aramid, nylon, or steel, for example, or other known material. Once formed, the uncured tire carcass forms a cylinder, which includes a pair of opposing open ends each including one of a pair of beads. The pair of opposing ends are spaced apart in an axial direction of the cylinder, such that the pair of opposing ends may also be referred to as opposing axial ends of the uncured tire carcass. The pair of opposing ends may also be referred to as a first axial end and a second axial end, each of which are in fluid communication with the interior chamber of the uncured tire carcass and the exterior atmosphere. The span of the cylinder between the pair of beads (or, more generally, between the pair of opposing ends) is referred to as a central portion of the uncured tire carcass, and generally comprises one or more plies of the reinforced polymeric material. It is appreciated that the uncured tire carcass forms a hollow cylinder, such that an interior chamber is arranged between the pair of open ends. Therefore, once the carcass is removed from the building surface, a hollow cylinder is provided such that the central portion is no longer supported by the building surface. Accordingly, it is the central portion that is at risk to buckle or otherwise deform after the uncured tire carcass is dismounted from a tire carcass building surface, since the central portion only comprises the one or more plies of uncured, reinforced elastomeric sheets. This risk is present whether the uncured tire carcass is arranged vertically (where a central longitudinal axis of the cylindrical tire carcass extends vertically), horizontally (where the central longitudinal axis of the cylindrical tire carcass extends horizontally), or any direction between vertical and horizontal.

To reduce the risk of deforming, bending, buckling and even collapsing, methods and systems are disclosed herein in accordance with particular embodiments for improving the stability and maintaining the intended shape of an uncured tire carcass during storage, handling, and transport after removal of the carcass from a tire carcass building surface.

In particular embodiments, the invention comprises a step of configuring an uncured tire carcass in a storage configuration subsequent to removing the uncured tire carcass from a tire carcass building surface. As noted above, once the uncured tire carcass is removed from a tire carcass building surface, the central portion of the uncured tire carcass is no longer supported by the building surface. In such embodiment, the tire carcass is generally uncured, whereby the various components assembled to form the tire carcass are not permanently bonded together and the tire carcass is pliable and unsupported. Additionally, the uncured tire carcass is generally cylindrical in form. However, an uncured tire carcass may take any form depending upon the tire carcass building surface employed, or as otherwise desired. The reinforced elastomeric material may comprise any such material known to one of ordinary skill.

In the storage configuration, it is appreciated that the uncured tire carcass may be arranged in any orientation relative to a ground plane. For example, in particular embodiments, the uncured tire carcass is arranged vertically in the storage configuration, where a central longitudinal axis of the cylindrical tire carcass extends vertically. In other embodiments, the uncured tire carcass is arranged horizontally in the storage configuration, where the central longitudinal axis of the cylindrical tire carcass extends horizontally, or any direction between vertical and horizontal.

Particular embodiments of the method for supporting an uncured tire carcass for storage, handling or transport of the tire carcass during tire production operations include a step of pressurizing the interior chamber of the uncured tire carcass to form an inflated uncured tire carcass. In pressurizing the interior chamber of the uncured tire carcass, it is appreciated that positively-pressurized gas is supplied into the interior chamber of the uncured tire carcass. As a result of performing this step, pressure is applied to an interior surface of the tire carcass by way of the pressurized gas contained in the interior chamber, which is deemed to “inflate” the uncured tire carcass, where the pressure in the interior chamber is greater than the pressure surrounding at least a portion of the tire carcass exterior. This positively-pressurized gas inflates the uncured tire carcass from the interior by increasing the tension within the one or more plies extending between the beads in the central portion of the tire carcass, where the weakest portion of the tire carcass is more resistant to deformation, bending, and buckling under the pressure of its own weight or structure.

In particular instances, the positively-pressurized gas is supplied directly from a pressure source into the interior chamber of the uncured tire carcass. Moreover, end caps may be provided at each axial to better contain the positively-pressured gas within the interior chamber, and which may further facilitate the supply of positively-pressurized gas from a pressure source into the interior chamber of the uncured tire carcass. It is appreciated that in particular variations, a cap may be applied to one or both pair of ends of the uncured tire carcass. The caps may comprise any desired design, and may or may not seal or facilitate sealing of the interior chamber from the exterior atmosphere at the corresponding end of the tire carcass. Particular embodiments of the end caps are discussed in further detail below with specific reference to the figures.

Once the interior chamber of the uncured tire carcass is pressurized, particular embodiments of the method for supporting an uncured tire carcass for storage, handling or transport of the tire carcass during tire production operations include a step of transferring the inflated uncured tire carcass while maintaining positive pressure within the interior chamber of the uncured tire carcass. To maintain positive pressure within the interior chamber of the uncured tire carcass, the positively-pressurized gas may be continually supplied to the interior chamber of the uncured tire carcass. Thereby, the uncured tire carcass remains mobile while pressurized. This may be accomplished by providing a pressure source and power supply that is portable with the uncured tire carcass. For example, in certain embodiments, a cap houses the pressure source, so to increase portability of the uncured tire carcass as the pressure source is able to move with the uncured tire carcass. It is appreciated that in instances when a cap is arranged along each of the pair of ends of the tire carcass, one or both caps may include a pressure source. Alternatively, the uncured tire carcass may be pressurized and sealed to increase portability as the pressure source no longer is required to remain in attached or in fluid communication with the uncured tire carcass. In particular instances, the pressure source is removed or detached from the inflated uncured tire carcass before transferring the inflated tire carcass. Particular variations are discussed in further detail below with specific reference to the figures.

In particular embodiments, the end caps are provided in a step of arranging a first end cap along a first axial end of the uncured tire carcass to at least partially cover, substantially cover, or fully cover the first axial end of the uncured tire carcass. The first axial end being open to the insider of the tire carcass. A second end cap may be arranged along a second axial end in a similar manner. To complete the step of pressurization, positively-pressurized gas is supplied from a pressure source into the interior chamber through one of the first axial end and second axial end of the uncured tire carcass. By example, the positively-pressurized gas may be supplied through a passageway extending into the interior chamber of the tire carcass. This passageway may extend through the end cap or between the end cap and the uncured tire carcass. Such passageways may include a conduit or aperture through or around the said end cap. The end cap may be further configured to receive and/or contain the pressure source. Finally, to regulate the pressurization of the interior chamber of the end caps may comprise a regulator or one or more vents.

In yet other embodiments, to transport the tire carcass, the uncured tire carcass may be placed on a conveyor, which may operate as a cap applied to one of the pair of ends of the tire carcass when the tire carcass is arranged vertically in the storage configuration. Any known mechanism or mechanisms for handling and/or transporting the uncured tire carcass when inflated may be employed, such as hooks, straps, cradles, for example. It is appreciated that any of these mechanisms may operate as and in fact comprise any end cap arranged along any of the pair of opposing ends of the uncured tire carcass. It is also appreciated that any of these handling or transporting mechanisms may include a pressure source or communicate pressurized gas from a pressure source. For example, in particular embodiments a conveyor include apertures communicating pressurized gas from a pressure source through the conveyor and into the interior chamber of the uncured tire carcass to supply and/or maintain the positively-pressurized gas in the interior chamber of the uncured tire carcass during carcass transfer operations.

The methods discussed above for supporting an uncured tire carcass for storage, handling or transport of the tire carcass during tire production operations will now be discussed below in association with particular embodiments shown in the figures.

With reference to FIG. 1 and FIG. 2, an uncured tire carcass 10 is shown with a first axial end 30 and a second axial end 130 of the uncured tire carcass. In this particular embodiment, the first axial end 30 and second axial end 130 each include a bead 80 about which one or more plies of uncured reinforced polymeric material wrap to form a folded portion. The one or more plies also extend between the beads 80 to form a central portion 90 of the uncured tire carcass. Positively-pressurized gas is supplied directly to an interior chamber 60 of the uncured tire carcass 10 from a pressure source 40. In particular, FIG. 1 shows the uncured tire carcass 10 with a pressure source 40, in perspective view. Likewise, FIG. 2 shows the uncured tire carcass 10 with a pressure source 40, in a cross-sectional view extending axially through the uncured tire carcass 10

With reference to FIG. 3 and FIG. 4, the uncured tire carcass 10 is shown with a first end cap 20 and a second end cap 120 in a cross-sectional view extending axially through the uncured tire carcass 10. The interior chamber 60 is illustrated between the first end cap 20 and the second end cap 120. A pressure source 40 and a passageway 50 is shown extending through the first end cap 20.

As noted above, in particular embodiments, the method and apparatus for supporting the uncured tire carcass 10 may comprise positioning an end cap 20 to cover at least one of the first axial end 30 and second axial end 130 of the uncured tire carcass 10. The end cap 20 may at least partially cover, substantially cover or completely cover the at least one of the first axial end 30 and second axial end 130 of the uncured tire carcass 10. Positively-pressurized gas is supplied through the end cap 20 into the interior chamber 60 of the uncured tire carcass 10. At least one end cap 20 may contain one or more passageways 50 extending through the end cap 20 into the interior chamber 60. Alternatively, a second end cap 120 may be provided to cover at least one axial end 130. The second end cap 120 may or may not additionally provide positively-pressured gas to the interior chamber 60 of the uncured tire carcass 10. To this end, positively-pressurized gas may be provided through any opening to the interior chamber 60 of the uncured tire carcass 10.

The first end cap 20 and/or second end cap 120 may be secured to the respective first axial end 30 and second axial end 130 of the uncured tire carcass 10. The end caps 20, 120 may be sealed to the respective axial end 30, 130 of the uncured tire carcass 10. A seal may be provided by any mechanical means known by one of ordinary skill in the art, including gaskets, clamps, etc. Alternatively, the end cap 20, 120 may be indirectly connected to the uncured tire carcass 10 or simply placed or positioned on the uncured tire carcass 10. By example, the end cap may be placed above or below the uncured tire carcass 10 if the axial direction of the tire carcass 10 is vertical. If, however, the axial direction of the tire carcass 10 is horizontal, the end cap may be placed to the front or rear of the uncured tire carcass 10. This includes being suspended above or below, or alternatively, positioned to the front or rear of the uncured tire carcass 10 by use of an independent structure.

The end cap 20, 120 may comprise any shape required to cover the respective axial end 30, 130 of the uncured tire carcass 10. By example, the end cap 20, 120 may be flat, a cone, an ellipse, etc. The end cap may extend into the interior chamber 60 of the uncured tire carcass 10 forming a recessed portion 160. Alternatively, the end cap may extend outward from the interior chamber 60 of the uncured tire carcass 10. The shape of the end cap 20, 120 may be used to facilitate placement or attachment of a pressure source 40 or passageway 50. By example, the shape of the end cap 20, 120 may assist with creating a seal or creating separation between the end cap 20, 120 and the uncured tire carcass 10. Further, the shape of the end cap 20, 120 may assist with maintaining the desired pressure within the interior chamber 60 of the uncured tire carcass 10. This may also be accomplished by using the shape of the end cap 20, 120 to reduce the volume of the interior chamber 60 of the uncured tire carcass 10. Moreover, the end cap 20, 120 may be formed to receive the pressure source within the perimeter of the uncured tire carcass 10. Such a structure would maintain the initial clearance of the uncured tire carcass 10. Finally, the end cap 20, 120 may also be formed with a structure for transporting the uncured tire carcass, including hooks or loops.

In particular embodiments, one or more end caps 20, 120 may be used on a single uncured tire carcass 10. End caps 20, 120 may additionally be modified to fit any opening in the uncured tire carcass 10. Likewise, more than one end cap 20, 120 may be used at a single opening in an uncured tire carcass 10. In contrast, an end cap 20, 120 may cover more than one uncured tire carcass 10. To this point, a single end cap may be used to secure, store, handle and transport more than one uncured tire carcass 10.

As noted above, a pressure source 40 supplies the positively-pressurized gas to the interior chamber 60 of the uncured tire carcass 10. The pressure source 40 may be connected to the passageway 50 which further extends through at least one end cap 20. The passageway 50 being open to the interior chamber 60 of the uncured tire carcass 10. The pressure source 40 may be a fan 110, a compressor or other positively-pressurized gas supply known by one of ordinary skill in the art. The pressure source 40 may be further connected to a power supply. The power supply may be independent of the pressure source 40 and extend to the pressure source 40 by a conduit or chord and, thereby, independent of the end cap 20, 120. Alternatively, the power supply may be integral to the pressure source 40. For example, the power supply may be a battery attached to the pressure source 40. The pressure source 40 and/or the power supply may be located at the end cap 20, 120. To this end, the end cap 20 may not require any external components. By not having any external components, the uncured tire carcass 10, with one or more end caps 20, 120, may be easily stored, transported or handled. The pressure source 40 may be located outside the tire carcass 10 wherein the positively-pressurized gas is supplied to the interior chamber 60 of the tire carcass 10 through the passageway 50 or, alternatively, located within the interior chamber 60 of the tire carcass 10.

The passageway 50 is in fluid communication with the interior chamber 60 of the tire carcass 10. In particular embodiments, the passageway 50 is in fluid communication with the pressure source 40 opposite the interior chamber 60 of the tire carcass. The passageway 50 may include an aperture in the end cap 20, an aperture between the end cap 20 and the uncured tire carcass 10, an aperture in the uncured tire carcass 10, a conduit extending through the end cap 20, a conduit extending between the end cap 20 and the uncured tire carcass 10, a conduit extending through the uncured tire carcass 10, a conduit extending through one of the aforementioned apertures, or the like. By example, the passageway 50 may be a conduit extending through the end cap 20. Alternatively, the passageway 50 may be a conduit extending between the uncured tire carcass 10 and the end cap 20, 120 or any other opening formed in the uncured tire carcass 10. The passageway 50 provides a pathway for the positively-pressurized gas to enter the interior chamber 60 of the uncured tire carcass 10. The passageway 50 accomplishes this by placing the pressure source 40 in fluid communication with the interior chamber 60 of the uncured tire carcass 10. However, as indicated above, a passageway 50 may not be necessary such as when the pressure source 40 is located directly within the interior chamber 60 of the uncured tire carcass 10.

In particular embodiments, additional features may be used to regulate the volume of the positively-pressurized gas supplied to the interior chamber 60 of the uncured tire carcass 10. Similarly, additional features may also be used to regulate the pressure maintained within the interior chamber 60 of the uncured tire carcass 10. A regulator may be used at the pressure source 40, the passageway 50, the end cap 20, 120, or the uncured tire carcass 10. Alternatively, the positively-pressurized gas may escape the interior chamber 60 of the uncured tire carcass 10 in a controlled manner between the end cap 20, 120 and the uncured tire carcass 10. Similarly, the end cap 20, 120 or the passageway 50 may include one or more vents to control the pressure within the interior chamber 60 of the uncured tire carcass 10. The vents may be adjustable. Likewise, the end cap 20, 120 may include more than one passageway 50 to control the pressure within the interior chamber 60 of the uncured tire carcass 10. If adjustable, the regulators, passageways 50 or vents may be controlled manually or by a controller.

With reference to FIG. 5 and FIG. 6, the uncured tire carcass 10 is shown on a conveyor 70. In particular, FIG. 5 shows the uncured tire carcass of 10 in a cross-sectional view extending axially through the uncured tire carcass 10. The conveyor 70 is positioned at the second axial end 130 of the uncured tire carcass 10 and a first end cap 20 is positioned at the first axial end 30 of the uncured tire carcass 10.

As noted above, the tire carcass 10 may be transported between steps in the production operations. Such means for transportation may include a conveyor 70. Other ways of handling the uncured tire carcass 10 may include hooks, straps or cradles. These structures may be used to form the end cap 20, 120 at one or more axial end 30, 130 of the uncured tire carcass 10. By example, the conveyor 70 may be positioned to cover at least one of the first axial end 30 and second axial end 130 of the uncured tire carcass 10. The conveyor 70 may further be or include a passageway 50. Moreover, the pressure source 40 may be in communication with the conveyor 70. In particular, the structure of the conveyor may be pressurized as the pressure source 40 with apertures for supplying the positively-pressurized gas to the uncured tire carcass 10. Therefore, by placing the uncured tire carcass on the conveyor 70 the interior chamber 60 of the uncured tire carcass 10 is inflated during transport. The other means for storing or handling the uncured tire carcass 10 may additionally be used as one or more end caps 20, 120 as illustrated by the conveyor 70, above.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention. Ranges that are described as being “between a and b” are inclusive of the values for “a” and “b” unless otherwise specified.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

1. A method for maintaining a desired shape of an uncured tire carcass when arranged in a storage configuration after the tire carcass has been removed from a building surface along which the uncured tire carcass was constructed, the method comprising:
configuring an uncured tire carcass in a storage configuration subsequent to removing the uncured tire carcass from a tire carcass building surface such that the uncured tire carcass is separated from the building surface;
pressurizing an interior chamber of the uncured tire carcass to form an inflated uncured tire carcass, during which the interior chamber of the uncured tire carcass is in fluid communication with an exterior atmosphere.

2. The method of claim 1 further comprising a step of:
transferring the inflated uncured tire carcass between locations while maintaining positive pressure within the interior chamber of the uncured tire carcass.

3. The method of claim 1, where the step of pressurizing comprises:
arranging a first end cap along a first axial end of the uncured tire carcass to at least partially cover the first axial end of the uncured tire carcass wherein the first axial end of the tire carcass is open to the inside of the tire carcass;
arranging a second end cap along a second axial end of the uncured tire carcass to at least partially cover the second axial end of the uncured tire carcass wherein the second axial end of the tire carcass is open to the inside of the tire carcass;
where the step of pressurizing occurs by supplying positively-pressurized gas from a pressure source into the interior chamber through one of the first axial end and the second axial end of the tire carcass while the first end cap and the second end cap are positioned on the respective first end and second end of the uncured tire carcass.

4. The method of claim 1, where the step of pressurizing comprises:
arranging a first end cap along a first axial end of the uncured tire carcass to substantially cover the first axial end of the uncured tire carcass wherein the first axial end of the tire carcass is open to the inside of the tire carcass;
arranging a second end cap along a second axial end of the uncured tire carcass to substantially cover the second axial end of the uncured tire carcass wherein the second axial end of the tire carcass is open to the inside of the tire carcass;
where the step of pressurizing occurs by supplying positively-pressurized gas from a pressure source into the interior chamber through one of the first axial end and the second axial end of the tire carcass while the first end cap and the second end cap are positioned on the respective first end and second end of the uncured tire carcass.

5. The method of claim 1, where in the step of arranging a second end cap along a second axial end of the uncured tire carcass includes positioning the uncured tire carcass on a conveyor, where the second end cap includes the conveyor.

6. The method of claim 5, where in the step of supplying positive-pressurized gas from a pressure source into the interior chamber through one of a first end and a second end of the tire carcass the pressure source communicates positively-pressurized gas through the conveyor.

7. The method of claim 1, where in the storage configuration the uncured tire carcass is positioned vertically such that a first axial end of the uncured tire carcass is positioned vertically above a second axial end of the uncured tire carcass.

8. The method of claim 3, and where in the tire carcass is positioned laterally such that the first end cap over the first axial end of the tire carcass is positioned to a side of the tire carcass.

9. The method of claim 3, where in the pressure source is arranged within the first end cap or the second end cap.

10. The method of claim 1, where in a pressure source directs pressurized gas into the tire carcass through a conveyor.

11. The method of claim 3, where in the pressure source is located in a recessed portion of the first end cap.

12. The method of claim 3, where in positive pressure is regulated within the tire carcass using one or more vents at the first end cap.

13. A support system for supporting an uncured tire carcass comprising:
a first end cap positioned at a first axial end of a tire carcass wherein the first axial end of the tire carcass is open to an inside of the tire carcass;
the first end cap configured to at least partially cover the first axial end;
the first end cap comprising,
a first end cap passageway open to the inside of the tire carcass wherein the first end cap passageway is connected to a pressure source;
the pressure source communicates positively-pressured gas into an interior chamber of the tire carcass through the first end cap passageway, during which the interior chamber of the uncured tire carcass is in fluid communication with an exterior atmosphere.

14. The support system of claim 13 further comprising:
a second end cap positioned at a second axial end of the tire carcass wherein the second axial end of the tire carcass is open to the interior chamber of the tire carcass;
the second end cap configured to at least partially cover the second axial end;

15. The support system of claim 14, wherein the second end cap comprises,
a second end cap passageway open to the interior chamber of the tire carcass wherein the second end cap passageway is connected to the pressure source;
the pressure source communicates the positively-pressured gas to the interior chamber of the tire carcass through the second end cap passageway.

16. The support system of claim 14, wherein the second end cap includes a conveyor.

17. The support system of claim 16, wherein the positively-pressured gas from the pressure source is supplied to the interior chamber of the tire carcass through one of the first axial end and the second axial end of the tire carcass where in the pressure source communicates the positively-pressurized gas through the conveyor.

18. (canceled)

19. The support system of claim 13, wherein the first end cap includes one or more vents to regulate the positively-pressurized gas within the interior chamber of the tire carcass.

20. The support system of claim 19, wherein at least one of the one or more vents are adjustable.

21. (canceled)

22. A support system for supporting an uncured tire carcass comprising:
a first end cap positioned at a first axial end of a tire carcass wherein the first axial end of the tire carcass is open to an inside of the tire carcass;
the first end cap configured to substantially cover the first axial end;
the first end cap comprising,
a first end cap passageway open to the inside of the tire carcass wherein the first end cap passageway is connected to a pressure source;
the pressure source communicates positively-pressured gas into an interior chamber of the tire carcass through the first end cap passageway, during which the interior chamber of the uncured tire carcass is configured to be in fluid communication with an exterior atmosphere.
